(19) United States
(12) Patent Application Publication
(10) Pub. No.: US 2009/0036346 A1
(43) Pub. Date: Feb. 5, 2009

(54) Fabric Conditioning Composition

(76) Inventors: Nigel Peter Bird, Wirral (GB); Lisa Emma Fildes, Wirral (GB); David Andrew Ross Jones, Wirral (GB); Srinivasa Rao Kandala, Trumbull, CT (US); Neil Fletcher Taylor, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/991,656

(22) PCT Filed: Aug. 18, 2006
(86) PCT No.: PCT/EP2006/008206

§ 371 Date: Jul. 17, 2008

(30) Foreign Application Priority Data
Sep. 9, 2005 (GB) 0518451.0

(51) Int. Cl. C11D 3/26

(52) U.S. Cl. 510/523

(57) ABSTRACT

An aqueous conditioning composition comprising: (i) a water-insoluble, non-ester, quaternary ammonium fabric conditioning agent having at least 2 alkyl and/or alkenyl groups of at least 12 carbon atoms, or an alkyl or alkenyl group having a chain length of at least 20 carbon atoms. (ii) a water-soluble quaternary ammonium cationic surfactant and (iii) perfume, at least a portion of which is encapsulated. The composition is made by a specific process which comprises adding the encapsulated perfume to water prior to the addition of the water-insoluble quaternary ammonium fabric conditioning agent and adding the water-soluble quaternary ammonium cationic surfactant after the addition of the water-insoluble quaternary ammonium fabric conditioning agent and any free perfume and at a temperature below the phase transition temperature of the composition.

### TECHNICAL FIELD

This invention relates to fabric conditioning compositions containing encapsulated perfume and a water-soluble quaternary ammonium compound and to their preparation.

### BACKGROUND TO THE INVENTION

Fabric conditioner compositions containing encapsulated perfumes for use as a rinse additive in laundry applications are known. The encapsulated perfume has the perceived advantage compared to free perfume that there is better delivery to the fabric from the rinse. Also loss during drying of the treated fabric is reduced e.g. in a tumble drier, and it will be gradually released from the fabric, e.g. by rupturing the capsules during use and/or wear of the garment and by gradual diffusion through the capsule shell. Fabric conditioner formulations comprising encapsulated perfumes are disclosed in U.S. Pat. No. 4,152,272, U.S. Pat. No. 4,464,271, U.S. Pat. No. 5,126,061, WO2003/02699, EP 397245, EP414283, KR2002044741 and KR 2003064502.

Initial studies have shown that encapsulated perfumes may be incompatible with water-soluble cationic surfactants, such as benzalkonium chloride, which may be otherwise desirable to use to control bacterial numbers on fabric, thereby reducing malodour generation. It has now been found that stability can be achieved with a very specific order of addition of the components during preparation of the composition. Furthermore it has been found that such products provide directionally higher perfume intensity after 24 hours and significantly higher intensity after 72 hours. The perfume intensity advantage is retained over 23 weeks storage at both 45° C. and ambient.

### SUMMARY OF THE INVENTION

According to one aspect of the invention there is provided an aqueous conditioning composition comprising:

(i) a water-insoluble, non-ester, quaternary ammonium fabric conditioning agent having at least 2 alkyl and/or alkenyl groups of at least 12 carbon atoms, or an alkyl or alkenyl group having a chain length at least 20 carbon atoms
(ii) a water-soluble quaternary ammonium cationic surfactant and
(iii) perfume, at least a portion of which is encapsulated, in a shell based on melamine/formaldehyde.

According to a second aspect of the invention there is provided a method of preparing a fabric conditioning composition comprising: (i) a water-insoluble, non-ester, quaternary ammonium fabric conditioning agent having at least 2 alkyl and/or alkenyl groups of at least 12 carbon atoms, or an alkyl or alkenyl group having a chain length of at least 20 carbon atoms, (ii) a water-soluble quaternary ammonium cationic surfactant and (iii) perfume, at least a portion of which is encapsulated, the method comprising adding the encapsulated perfume to water prior to the addition of the water-insoluble quaternary ammonium fabric conditioning agent and adding the water-soluble quaternary ammonium cationic surfactant after the addition of the water-insoluble quaternary ammonium fabric conditioning agent and any free perfume and at a temperature below the phase transition temperature of the composition.

It has been found that excellent long term stability can be achieved with a very specific order of addition wherein the slurry of encapsulated perfume is added to the charge water and the water-soluble cationic surfactant is added after the addition of the water-insoluble fabric softening agent and any free perfume and at a temperature below the phase transition temperature of the composition. It is postulated that this order of addition ensures that the capsules of perfume become coated with the water-insoluble surfactant rather than the water-soluble surfactant and this is a key factor in achieving improved stability. The reason why the addition of the water-soluble surfactant has to be after the addition of free perfume is unknown.

### The Cationic Fabric Softener

The water-insoluble fabric softener can be any fabric-substantive quaternary ammonium compound which, in pure form as a strong acid salt (e.g. chloride), has a solubility in distilled water at pH 2.5 and 20° C. of less than 1 g/l, preferably less than 0.1 g/1 more preferably less than 0.01 g/l or can be a mixture of such compounds. In this context, the soluble fraction of the surfactant is taken to be that material which cannot be separated from water by centrifugal action and which passes a 100 nm Nuclepore filter (registered trade mark). Preferred materials are compounds having two —C₁₂-C₂₄ alkyl or alkenyl groups, or a quaternary ammonium compound comprising a single chain with an average chain length equal to or greater than C₂₀.

Examples of substantially water-insoluble mono-ammonium compounds are the quaternary ammonium compounds having the formula:—

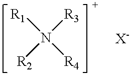

wherein
R₁ and R₂ independently represent alkyl or alkenyl groups of from about 12 to about 24 carbon atoms;
R₃ and R₄ independently represent hydrogen, alkyl, alkenyl or hydroxyalkyl groups containing from 1 to about 4 carbon atoms; and
X is the salt counter-anion, preferably selected from halide, methyl sulfate and ethyl sulfate radicals.

Representative examples of these quaternary softeners include ditallow dimethyl ammonium chloride; ditallow dimethyl ammonium methyl sulfate; dihexadecyl dimethyl ammonium chloride; di(hydrogenated tallow alkyl)dimethyl ammonium chloride; dioctadecyl dimethyl ammonium chloride; dieicosyl dimethyl ammonium chloride; didocosyl dimethyl ammonium chloride; di(hydrogenated tallow) dimethyl ammonium methyl sulfate; dihexadecyl diethyl ammonium chloride; di(coconut alkyl)dimethyl ammonium chloride and di(coconut alkyl)dimethyl ammonium methosulfate. Of these ditallow dimethyl ammonium chloride and di(hydrogenated tallow alkyl)dimethyl ammonium chloride are preferred.

The iodine value of the softening agent is preferably from 0 to 120 more preferably from 0 to 100, and most preferably from 0 to 50. Essentially saturated material, i.e. having an iodine value of from 0 to 1, is used in especially high performing compositions. At low iodine values, the softening performance is excellent and the composition has improved resistance to oxidation and associated odour problems upon storage.

Iodine value is defined as the number of grams of iodine absorbed per 100 g of test material. NMR spectroscopy is a suitable technique for determining the iodine value of the softening agents of the present invention using the method described in Anal. Chem., 34, 1136 (1962) by Johnson and Shoolery and in EP 593,542 (Unilever, 1993).

The water-insoluble fabric softener is present in an amount in the range from 0.05 to 50, preferably 1 to 25 more preferably from 3 to 15% by weight of the compositions.

Reference to levels of cationic softening agent in this specification are to the total level of cationic softening agent, including all cationic components of a complex raw material that could enter the aqueous lamellar phase together.

### The Water-Soluble Surfactants

The water-soluble surfactant is a cationic surfactant having a solubility in distilled water at pH 2.5 and 20° C. of greater than 1 g/l. Once again, the solubility of the cationic surfactant is defined with reference to the pure material in the form of a strong acid salt (e.g. chloride), and the soluble fraction of the surfactant is taken to be that material which cannot be separated from water by centrifugal action and which passes a 100 nm Nuclepore filter.

Preferred water-soluble cationic surfactants are mono-C₈-C₂₄ alkyl or alkenyl ammonium salts, imidazolinium salts, pyridinium salts and mixtures thereof.

Suitable water-soluble mono-ammonium compounds have the general formula:

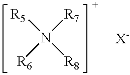

wherein:
R₅ represents a C₈-C₂₄ alkyl or alkenyl group,
R₆ represents hydrogen, a C₁-C₁₂ alkyl, alkenyl or hydroxyalkyl group, an aryl group, a
C₁₋₆ alkylaryl group, or a poly(ethylene oxide) group having from 2 to 20 ethylene oxide units,
R₇ and R₈ individually represent hydrogen, a C₁-C₄ alkyl, alkenyl or hydroxyalkyl group or a poly(ethylene oxide) group having from 2 to 20 ethylene oxide units and
X is as defined above.

Preferred materials of this general type include the tallow trimethyl ammonium salts, cetyl trimethyl ammonium salts, myristyl trimethyl ammonium salts, coconut alkyl trimethyl ammonium salts, cetyl dimethyl ammonium salts, myristyl dimethyl ammonium salts, coconut alkyl dimethyl ammonium salts, oleyl methyl ammonium salts, palmityl methyl ammonium salts, myristyl methyl ammonium salts, lauryl methyl ammonium salts, dodecyl dimethyl hydroxyethyl ammonium salts, dodecyl dimethyl hydroxypropyl ammonium salts, myristyl dimethyl hydroxyethyl ammonium salts, dodecyl dimethyl dioxyethylenyl ammonium salts, myristyl benzyl hydroxyethyl methyl ammonium salts, coconut alkyl benzyl hydroxyethylmethyl ammonium salts, dodecyl dihydroxyethyl methyl ammonium salts, cetyl dihydroxyethyl methyl ammonium salts, and stearyl dihydroxyethyl methyl ammonium salts. The most preferred compound is benzalkonium chloride. Another suitable material is a mixture of octyldecyldimethyl ammonium chloride, didecyldimethyl ammonium chloride and dioctyldimethyl ammonium chloride.

Preferred water-soluble imidazolinium materials are represented by the general formula:

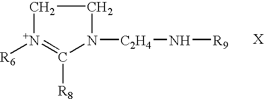

or acids salts thereof,
wherein R₆, R₇, R₈ and X were defined earlier and R₉ represents H, alkyl, alkenyl, COR where R is alkyl or alkenyl. Preferred imidazolinium salts of this general formula include the compound in which R₆ is methyl, R₈ is tallowyl and R₉ is hydrogen and the compound in which R₈ is palmitoyl and R₉ is hydrogen.

Highly preferred water-soluble polyammonium cation materials are represented by the general formula:

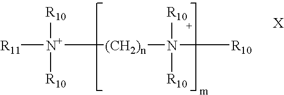

wherein:
R₁₁ is selected from an alkyl or alkenyl group having from 12 to 24, preferably from 16 to 20 carbon atoms in the alk(en)yl chain, R₁₁—CO— and R₁₁—O—(CH₂)ₙ—;
each R₁₀ is independently selected from hydrogen, —(C₂H₄O)ₚH, —(C₃H₆O)_{q}H, —(C₂H₄O)ᵣ(C₃H₆O)ₛH, a C₁₋₃ alkyl group and the group —(CH₂)ₙ—NR′₂,
wherein:
R′ is selected from hydrogen, —(C₂H₄O) pH, —(C₂H₄O) p (C₃H₆O)_{q}H and C₁₋₃ alkyl;
n is an integer from 2 to 6, preferably 2 or 3;
m is an integer from 1 to 5, preferably 1 or 2;
p, q, r and s are each a number such that the total p+q+r+s in the molecule does not exceed 25 (preferably, each p and q is 1 or 2 and each r and s is 1); and
X represents one or more anions having total charge balancing that of the nitrogen atoms.

Preferred water-soluble cationic materials are alkoxylated and contain not more than one —C₂H₄OH or —C₃H₆OH group attached to each nitrogen atom, except that up to two of these groups can be attached to a terminal nitrogen atom which is not substituted by an alkyl group having from 10 to 24 carbon atoms.

Polyamine species suitable for use herein include:
N-tallowyl,N,N′,N′-tris(2-hydroxyethyl)1,3-propanediamine di-hydrochloride or dibenzoate;
N-soybean alkyl 1,3-propane diammonium sulfate;
N-stearyl,N,N-di(2-hydroxyethyl)-N′-(3-hydroxypropyol)-1,3-propanediamine dihydrofluoride;
N-cocoyl N,N,N′,N′,N′-pentamethyl-1,3-propane diammonium dichloride or di-methosulfate;
N-oleyl N,N′,N′-tris(3-hydroxypropyl)-1,3-propanediamine dihydrofluoride;
N-stearyl N,N′,N′-tris(2-hydroxyethyl) N,N′-dimethyl-1,3-propanediammonium dimethylsulfate;
N-palmityl N,N′,N′-tris(3-hydroxypropyl)-1,3-propane-diamine dihydrobromide;
N-(stearyloxypropyl) N,N′,N′-tris(3-hydroxypropyl)1,3-propanediammonium diacetate;
N-tallowyl N-(3-aminopropyl)1,3-propanediamine tri-hydrochloride;
N-oleyl N—N″,N″bis(2-hydroxyethyl)-3-aminopropyl/N′,N′-bis(2-hydroxyethyl)1,3diaminopropane trihydrofluoride;
N-tallowyl diethylene triamine trihydrochloride.

The water-soluble cationic surfactant herein can also be represented by alkyl pyridinium salts having the following formula:

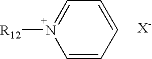

wherein R₁₂ is a C₁₀-C₂₄, preferably C₁₆ or —C₁₈ alkyl radical and X is a suitable anion as defined hereinbefore, preferably a halide, especially chloride or bromide.

It should be understood, of course, that water-soluble cationic surfactants of the amine-salt class can be added in the form of the neutral amine followed by pH adjustment to within the range from a pH of about 2.5 to about 7.

The water-soluble cationic surfactant is generally present in an amount of from 0.05 to 8, preferably 0.2 to 5, more preferably 0.25 to 2% by weight of the composition.

### Encapsulated Perfume

The encapsulated perfume comprises a liquid core of fragrance encapsulated within a shell. It is preferred that the shell comprises a single layer of polymer and is uncoated.

Encapsulated perfumes are known and disclosed, for example in GB 2006709, EP 414283, EP 1393706, EP 1407753, EP 1533364, U.S. Pat. No. 4,100,103, U.S. Pat. No. 4,396,670, U.S. Pat. No. 4,464,271, U.S. Pat. No. 4,525,520, U.S. Pat. No. 5,011,634, U.S. Pat. No. 5,089,339, U.S. Pat. No. 5,126,061, U.S. Pat. No. 5,137,646, WO02/074436, WO03/02699, KR 2002044741 and KR 2003064502.

Preferred encapsulated perfumes have a shell based on melamine/formaldehyde.

Generally the compositions comprise from 0.1 to 5% by weight of perfume and at least 2% of the perfume is encapsulated. Generally the weight ratio of free perfume to encapsulated perfume is in the range 98:2 to 10:90, preferably 80:20 to 20:80.

### Fatty Coactive

An optional component in the compositions of the present invention is a fatty coactive. Such agents typically have a C₈ to C₂₂ hydrocarbyl chain present as part of their molecular structure. Suitable fatty complexing agents include CB to C₂₂ fatty alcohols and C₈ to C₂₂ fatty acids; of these, the C₈ to C₂₂ fatty alcohols are most preferred.

Preferred fatty acid coactives include hardened tallow fatty acid (available as e.g. Pristerene 4916, ex. Uniqema).

Preferred fatty alcohol coactives include C₁₆/C₁₈ fatty alcohols (available as Stenol and Hydrenol ranges, ex. Cognis, and Laurex CS, ex. Huntsman) and behenyl alcohol, a C₂₂ fatty alcohol, available as Lanette 22, ex. Cognis.

The fatty coactive may be used at from 0.05%, particularly at from 0.2% to 5%, and especially at from 0.4 to 2% by weight, based on the total weight of the composition.

Co-softeners may be used together with the quaternary ammonium softening agent. When employed, they are typically present at from 0.1 to 20% and particularly at from 0.5 to 10%, based on the total weight of the composition. Preferred co-softeners include fatty esters, and fatty N-oxides.

Other fatty esters that may be employed include fatty monoesters, such as glycerol monostearate, fatty sugar esters, such as those disclosed in WO01/46361 (Unilever).

### Further Optional Ingredients

The compositions of the invention may contain one or more other ingredients. Such ingredients include preservatives, pH buffering agents, perfume carriers, fluorescers, colourants, hydrotropes, antifoaming agents, anti-redeposition agents, soil-release agents, electrolytes, enzymes, optical brightening agents, anti-shrinking agents, anti-wrinkle agents, anti-spotting agents, anti-oxidants, sunscreens, anti-corrosion agents, drape imparting agents, anti-static agents, ironing aids and dyes.

A particularly preferred optional ingredient is an opacifier or pearlescer. Such ingredients can serve to further augment the creamy appearance of the compositions of the invention. Suitable materials may be selected from the Aquasol OP30X range (ex. Rohm and Haas), the PuriColour White range (ex. Ciba) and the LameSoft™ range (ex. Cognis). Such materials are typically used at a level of from 0.01 to 1% by weight of the total composition.

### Product Use

The compositions of the present invention are preferably rinse conditioner compositions and may be used in the rinse cycle of a domestic laundry process.

The composition is preferably used in the rinse cycle of a home textile laundering operation, where, it may be added directly in an undiluted state to a washing machine, e.g. through a dispenser drawer or, for a top-loading washing machine, directly into the drum. Alternatively, it can be diluted prior to use. The composition may also be used in a domestic hand-washing laundry operation.

It is also possible, though less desirable, for the compositions of the present invention to be used in industrial laundry operations e.g. as a finishing agent for softening agent for softening new clothes prior to sale to consumers.

The invention will be illustrated by the following Examples in which all parts and percentages are by weight unless otherwise directed.

### EXAMPLES

A series of compositions were prepared at 2 litre scale with the same formulation but different processes. The formulation was:

| Component | Chemical Name | Supplier | Level |
|---|---|---|---|
| Arquad 2HT-75 (75% | Dihardened | Akzo | 6.5% (on a 100% |
| Quat/25% IPA water) | tallow dimethyl | | basis) |
| | ammonium | | |
| | chloride | | |
| Pristerine 4916 | Hardened tallow | Uniqema | 1.08% |
| | fatty acid | | |
| Benzalkonium chloride | Benzalkonium | Aldrich | 0.4% |
| (50% in water) | chloride | | |
| ‘Merlin’ Perfume | | Givaudan | 0.89% |
| Aroma Ball Type 1 | Melamine- | Polychrom | 0.4% of perfume |
| encaps with ‘Merlin’ | formaldehyde | | oil in encaps |
| perfume (1) | based encaps | | |
| Electrolyte | Calcium | VWR | 0.002% |
| | chloride 2H2O | | |

Minors, dye and preservative were also present in the formulation.

The approximate composition of the capsules is:

| | % |
|---|---|
| Perfume | 25 |
| Melamine | 3 to 4 |
| Emulsifier | 2 to 3 |
| Water | 70 |

The Tables below show the details of the order of addition for the different Examples and the visual stability of the samples. Of these only Example 1 showed longer term stability (i.e. visco-stability of over one month). Stability was determined by visual assessment.

### Matrix of Prototypes

| | Order of Addition | | | | | |
|---|---|---|---|---|---|---|
| Example | 1 | 2 | 3 | 4 | 5 | 6 |
| 1 | Water | Encaps | 2HT | Fatty | Perfume | BKC |
| | | | | acid | | |
| A | Water | 2HT | Fatty | BKC | Perfume | Encaps |
| | | | acid | | | |
| B | Water | 2HT | Fatty | Perfume | Encaps | BKC |
| | | | acid | | | |
| C | Water | 2HT | Fatty | Perfume | Encaps | BKC (post |
| | | | acid | | | addition |
| D | Water | Encaps | 2HT | Fatty | BKC | Perfume |
| | | | | acid | | |
| E | Water | BKC and Encaps | | 2HT | Fatty | Perfume |
| | | | | | acid | |
| F | Water | 2HT | Fatty | BKC | Perfume and Encaps | |
| | | | acid | | | |
| G | Water | 2HT | Fatty | Encaps | Perfume | BKC |
| | | | acid | | | |

| | | | | | |
|---|---|---|---|---|---|
| H | Water | 2HT | Fatty | Encaps and Perfume | BKC |
| | | | acid | | |

Visual stability of prototypes (stored at ambient and 45° C.)

| | | Week 1 | | Week 2 | |
|---|---|---|---|---|---|
| Prototype | Initial | Ambient | 45° C. | Ambient | 45° C. |
| 1 | OK | OK | OK | OK | OK |
| A | OK | PPT | OK | PPT | OK |
| B | OK | PPT | PPT | PPT | PPT |
| C | PPT | THICK | THICK | — | — |
| D | LUMPY | LUMPY | THICK | — | — |
| E | LUMPY | LUMPY | LUMPY | — | — |
| F | OK | PPT | OK | PPT | OK |
| G | OK | PPT | PPT | PPT | PPT |
| H | OK | OK | PPT | OK | PPT |

The process of Example 1 in more detail is given below:

1. Charge water set between 60 to 65° C., add Encaps and mix for 5 minutes
2. Add molten active and fatty acid over 1 minute
3. Continue to mix until a temperature drops to 35 to 42° C.
4. Add perfume and mix for 5 minutes
5. Add BKC and mix for 5 minutes
6. Add salt to reach desired viscosity

Example 1 was scaled up to 3.5 litres and a more extensive evaluation conducted.

The product showed good storage stability at room temperature and 45° C. as shown in the following Table.

| | |
|---|---|
| | Viscosity at 106 s⁻¹ (mPas) |
| Sample age | Storage temperature |

| (weeks) | Ambient | 45° C. |
|---|---|---|
| 0 | 101 | 101 |
| 1 | 99.8 | 100.2 |
| 2 | 100.1 | 99.9 |
| 3 | 101.8 | 103.8 |
| 4 | 105.4 | 110.4 |
| 6 | 104.9 | 112.4 |
| 8 | 110.2 | 115.4 |
| 10 | 100.1 | 106.8 |
| 12 | 99.7 | 102.4 |
| 14 | 98.7 | 101.4 |
| 16 | 95.4 | 96.7 |

A series of tests was conducted to investigate the perfume intensity of fabric treated with the fabric conditioner samples of Example 1 compared with a control of the same formulation with the exception that the benzalkonium chloride was omitted.

Perfume assessment was carried out using terry towelling monitors (size 20 cm×20 cm) which were pre-washed in Thai Breeze washing powder in a Tergotometer. The monitors were taken out of the Tergotometer pot and wrung out. The monitors were then rinsed in a solution of the appropriate fabric conditioner treatment for 5 minutes. The monitors were removed and squeezed dry. The perfume intensity on the monitors was assessed wet, after 24 hours and after 72 hours by a trained panel.

Perfume intensity was measured by a trained panel on a scale from (no perfume) to 5 (very intense perfume). The following Table reported the perfume.

Intensity scores on dry cloth, 72 hours after treatment stored at ambient temperature.

| | |
|---|---|
| Sample age | Perfume intensity |

| (weeks) | Control | Example 1 |
|---|---|---|
| 0 | 0.46 | 1.05 |
| 4 | 0.37 | 1.14 |
| 8 | 0.51 | 1.24 |
| 10 | 0.49 | 1.12 |
| 12 | 0.45 | 1.15 |
| 14 | 0.39 | 1.08 |
| 18 | 0.41 | 0.97 |
| 20 | 0.34 | 0.87 |
| 23 | 0.27 | 1.01 |

1. An aqueous conditioning composition comprising:
(i) a water-insoluble, non-ester, quaternary ammonium fabric conditioning agent having at least 2 alkyl and/or alkenyl groups of at least 12 carbon atoms, or an alkyl or alkenyl group having a chain length of at least 20 carbon atoms.
(ii) a water-soluble quaternary ammonium cationic surfactant and
(iii) perfume, at least a portion of which is encapsulated in a shell based on melamine/formaldehyde.

2. An aqueous conditioning composition in which the fabric conditioning agent has the formula: 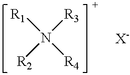
wherein
R₁ and R₂ independently represent alkyl or alkenyl groups of from about 12 to about 24 carbon atoms;
R₃ and R₄ independently represent alkyl, alkenyl or hydroxyalkyl groups containing from 1 to about 4 carbon atoms; and
X is the salt counter-anion, preferably selected from halide, methyl sulfate and ethyl sulfate radicals.

3. An aqueous fabric conditioning composition as claimed in claim 1 in which the fabric conditioning agent has a iodine value of from 0 to 50.

4. An aqueous fabric conditioning composition as claimed in claim 1 in which the fabric conditioning agent is present in an amount of from 0.5 to 50, preferably 1 to 25, more preferably 3 to 20% by weight of the composition.

5. An aqueous fabric conditioning composition as claimed in claim 1 in which the water-soluble quaternary ammonium cationic surfactant has the formula: 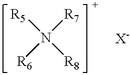
wherein:
R₅ represents a C₈-C₂₄ alkyl or alkenyl group,
R₆ represents hydrogen, a C₁-C₁₂ alkyl, alkenyl or hydroxyalkyl group, an aryl group, a
C₁₋₆ alkylaryl group, or a poly(ethylene oxide) group having from 2 to 20 ethylene oxide units, R₇ and R₈ individually represent hydrogen, a C₁-C₄ alkyl, alkenyl or hydroxyalkyl group or a poly(ethylene oxide) group having from 2 to 20 ethylene oxide units and
X is as defined above.

6. An aqueous fabric conditioning composition as claimed in claim 5 in which the water-soluble quaternary ammonium cationic surfactant is benzalkonium chloride.

7. An aqueous fabric conditioning composition as claimed in claim 1 in which the water-soluble quaternary ammonium cationic surfactant is present in an amount of from 0.05 to 8, preferably 0.2 to 5, more preferably 0.25 to 2% by weight of the composition.

8. An aqueous fabric conditioning composition as claimed in claim 1 in which the composition comprises from 0.1 to 5% by weight of perfume and at least 2% by weight of said perfume is encapsulated.

9. An aqueous fabric conditioning composition as claimed in claim 8 in which the weight ratio of free to encapsulated perfume is in the range 98:2 to 10:90, preferably 80:20 to 20:80.

10. An aqueous fabric conditioning as claimed in claim 1 in which the composition additionally comprises a fatty coactive agent selected from fatty acids and fatty alcohols.

11. An aqueous fabric conditioning composition as claimed in claim 10 in which the fatty coactive is hardened tallow fatty acid.

12. An aqueous fabric conditioning composition as claimed in claim 10 in which the fatty coactive is present in an amount of from 0.05 to 10, preferably 0.2 to 5, more preferably 0.4 to 2% by weight of the compositions.

13. A method of preparing a fabric conditioning composition comprising:
(i) a water-insoluble, non-ester, quaternary ammonium fabric conditioning agent having at least 2 alkyl and/or alkenyl groups of at least 12 carbon atoms, or an alkyl or alkenyl group having a chain length of at least 20 carbon atoms.
(ii) a water-soluble quaternary ammonium cationic surfactant and
(iii) perfume, at least a portion of which is encapsulated,
the method comprising adding the encapsulated perfume to water prior to the addition of the water-insoluble quaternary ammonium fabric conditioning agent and adding the water-soluble quaternary ammonium cationic surfactant after the addition of the water-insoluble quaternary ammonium fabric conditioning agent and any free perfume and at a temperature below the phase transition temperature of the composition.

14. (canceled)
